(19) United States
(12) Patent Application Publication
(10) Pub. No.: US 2006/0189233 A1
(43) Pub. Date: Aug. 24, 2006

(54) Protective device for the passenger compartment of a vehicle and method for producing a flexible sheet-like structure

(76) Inventors: Bouaziz Belibel, Waeschenbeuren (DE); Achim Krueckemeier, Filderstadt (DE)

Correspondence Address: FLYNN THIEL BOUTELL & TANIS, P.C., 2026 RAMBLING ROAD, KALAMAZOO, MI, 49008-1631, US

(21) Appl. No.: 11/354,658

(22) Filed: Feb. 15, 2006

(30) Foreign Application Priority Data
Feb. 24, 2005 (DE) 102005009699.9

(51) Int. Cl. B32B 5/02; B32B 27/12; D04H 1/46

(52) U.S. Cl. 442/59; 442/394; 442/408; 442/402

(57) ABSTRACT

1. A protective device for the passenger compartment of a vehicle. 2.1 A protective device for the passenger compartment of a vehicle with a flexible sheet-like structure, which is held in the region of one extreme end on a winding shaft in such a way that it can be wound up and unwound and is connected in the region of its other extreme end to a drawing-out profile, is known. 2.2 According to the invention, it is provided that the sheet-like structure is formed in two layers from a backing nonwoven and an applied, weldable layer of plastic as a top layer. 2.3 Use for passenger cars

The invention relates to a protective device for the passenger compartment of a vehicle with a flexible sheet-like structure and to a method for producing a flexible sheet-like structure for such a protective device.

A protective device for the passenger compartment of a vehicle in the form of a cargo compartment cover is known from EP 01 433 660 A1. The known cargo compartment cover has a flexible sheet-like structure in the form of a Malivlies, which is fastened in the region of one extreme end to a winding shaft and is connected in the region of an opposite extreme end to a drawing-out profile.

The object of the invention is to provide a protective device and a method of the type mentioned at the beginning which make it possible for the sheet-like structure to be connected in a simple and low-cost manner to adjacent components, such as in particular a winding shaft or drawing-out profile.

This object is achieved for the protective device by the sheet-like structure being formed in more than one layer from a backing nonwoven and an applied, weldable layer of plastic as a top layer. The sheet-like structure is preferably made up of two layers. However, apart from the two layers described, it is also possible for there to be at least one further layer. The backing nonwoven may be formed as a Malivlies or Maliwaft. Alternatively, the backing nonwoven may be made as a different type of nonwoven structure, in particular a stitch-bonded or hydroentangled nonwoven. It is also advantageous to provide such a nonwoven structure with additional stitching by a sewing thread. Such backing nonwovens are inexpensive, in particular in comparison with woven or knitted fabrics, and nevertheless have adequate rigidity and strength to serve as a backing material for the sheet-like structure. The applied layer of plastic does not have to have a supporting function of its own and can accordingly be made relatively thin. The weldability of the layer of plastic makes it possible for the sheet-like structure to be easily attached to adjacent components, such as in particular a drawing-out profile, contoured part or the like. It is advantageously possible to produce a coating for such a contoured part from the same plastics material and to achieve easy welding with the layer of plastic of the sheet-like structure. A PVC layer is provided particularly advantageously as the layer of plastic. This is so because the PVC layer is weldable and inexpensive. The layer of plastic may be colored and textured in a desired way, in particular for design purposes. If PVC or another plastics material is used, adequate flame resistance and light fastness can be achieved. Use of the backing nonwoven makes it possible to obtain a damped rolling noise when winding up or unwinding the sheet-like structure in relation to the winding shaft. For the purposes of the invention, protective devices are, in particular, cargo compartment covers for motor vehicles, in particular for passenger cars, but also devices for providing protection from the sun or light in the region of glass roofs or side or rear window regions of the motor vehicle, in order to permit shading, in particular in the form of full shading.

In a particularly advantageous way, the layer of plastic is formed by a PVC layer. This is applied in particular by laminating, calendering, brushing or extruding onto the backing nonwoven in liquid form, a very thin and uniform coating being achievable. This produces a considerable weight reduction for the sheet-like structure.

In a further refinement of the invention, the layer of plastic is formed by a film of plastic. This film of plastic is preferably a PVC film. The film of plastic may be advantageously joined to the backing nonwoven, in particular adhesively bonded. Adhesive layers, which are either already present on the film of plastic or are applied by appropriate application methods when the two layers are brought together, may be used for the adhesive bonding.

For the method for producing a flexible sheet-like structure for such a protective device, the object on which the invention is based is achieved by the layer of plastic being applied to the backing nonwoven in liquid form. This makes it possible to achieve a particularly thin and nevertheless uniform coating, whereby on the one hand a cost reduction and on the other hand a weight reduction is achieved in comparison with conventional PVC sheet-like structures for cargo compartment covers. A coating is advantageously performed by calendering.

In a refinement of the method, the layer of plastic is applied by doctor-blading or brushing. In this way, the sheet-like structure can be created particularly advantageously in a continuous production operation. This involves the nonwoven being impregnated with the plastic, whereby the weldability of the sheet-like structure is increased.

It is alternatively envisaged to apply the layer of plastic by extrusion.

According to the invention, the backing nonwoven is produced first, in that a suitable web of fibers is bonded by stitchbonding or hydroentanglement to form a nonwoven structure. After completion of the backing nonwoven, the layer of plastic is then applied.

The fact that the protective device comprises a sheet-like structure which is provided on the underside with the backing nonwoven and on the upper side with the layer of plastic means that, in the wound-up state on the winding shaft, there is always a wound layer of backing nonwoven and a wound layer of plastic on top of one another. This reliably avoids adhesive bonding in the wound-up state, so that, along with the pleasant and quiet rolling noise during winding-up and unwinding, uniform winding-up or drawing-off forces are also ensured. Moreover, adhesive bonding in the wound-up state is also avoided, so that the rolled-up sheet-like structure can be stored for long periods of time. The top layer, formed by the layer of plastic, permits adaptation in particular to decorative or design aspects of the remaining interior trim of the motor vehicle, so that a consistent overall impression of the passenger compartment of the vehicle can also continue in the region of the protective device. This particularly allows adaptation to the color and grain effect of the interior design concept to be achieved.

1. A protective device for the passenger compartment of a vehicle with a flexible sheet-like structure, which is held in the region of one extreme end on a winding shaft in such a way that it can be wound up and unwound and is connected in the region of its other extreme end to a drawing-out profile, wherein the sheet-like structure is formed in more than one layer from a backing nonwoven and an applied, weldable layer of plastic as a top layer.

2. The protective device as claimed in claim 1, wherein the layer of plastic is formed by a PVC layer.

3. The protective device as claimed in claim 1, wherein a Malivlies or a Maliwatt is provided as the backing nonwoven.

4. The protective device as claimed in claim 1, wherein the layer of plastic is formed by a film of plastic.

5. The protective device as claimed in claim 4, wherein the film of plastic is made as a PVC film.

6. The protective device as claimed in claim 4, wherein the film of plastic is joined to the backing nonwoven, in particular adhesively bonded.

7. The protective device as claimed in claim 1, wherein the backing nonwoven is produced by stitchbonding or hydroentanglement.

8. The protective device as claimed in claim 7, wherein the backing nonwoven is additionally stitched by means of a sewing thread.

9. A method for producing a flexible sheet-like structure for a protective device as claimed in claim 1, wherein the layer of plastic is applied to the finished backing nonwoven in liquid form.

10. The method as claimed in claim 9, wherein the layer of plastic is applied by doctor-blading.

11. The method as claimed in claim 9, wherein the layer of plastic is applied by extrusion.
